(19) United States
(12) Patent Application Publication
(10) Pub. No.: US 2019/0123404 A1
(43) Pub. Date: Apr. 25, 2019

(54) APPARATUS WITH BATTERY TEMPERATURE CONTROL

(71) Applicant: Samsung Electronics Co., Ltd., Suwon-si (KR)

(72) Inventors: YoungJae KIM, Seoul (KR); Jinyong JEON, Yongin-si (KR); Young Hun SUNG, Hwaseong-si (KR); DaeBong JUNG, Seongnam-si (KR)

(73) Assignee: Samsung Electronics Co., Ltd., Suwon-si (KR)

(21) Appl. No.: 15/955,999

(22) Filed: Apr. 18, 2018

(30) Foreign Application Priority Data
Oct. 24, 2017 (KR) 10-2017-0138584

(51) Int. Cl. H01M 10/625; H01M 10/63; H04B 5/00; H01M 2/10; B60L 11/18

(52) U.S. Cl. CPC H01M 10/625; H01M 10/63; B60L 11/1861; H04B 5/0031; H01M 2/1083; H04B 5/0037

(57) ABSTRACT

A battery temperature controlling apparatus includes a battery pack and a controller. The battery pack includes battery modules, and at least one of the battery modules includes an antenna and a coil. The antenna is configured to communicate with a corresponding adjacent one of the battery modules. The coil is configured to transmit and receive power with the corresponding adjacent one of the battery modules. The controller is configured to control a temperature of the battery pack based on information of the battery pack.

### CROSS-REFERENCE TO RELATED APPLICATIONS

This application claims the benefit under 35 USC § 119(a) of Korean Patent Application No. 10-2017-0138584 filed on Oct. 24, 2017 in the Korean Intellectual Property Office, the entire disclosure of which is incorporated herein by reference for all purposes.

### BACKGROUND

### 1. Field

The following description relates to an apparatus with battery temperature control.

### 2. Description of Related Art

With the onset of environmental and energy resource issues, electric vehicles are being regarded as the future of transportation. Electric vehicles and devices use rechargeable battery packs that can be discharged and charged as a primary or secondary power source. The battery pack may include a plurality of secondary cells.

Accordingly, the lifespan of the battery pack is an important factor to consider in an electric vehicle. Increasing the capacity of the battery pack may increase the lifespan of the battery pack; however, merely adding more battery cells to the battery pack to increase the lifespan of the battery pack may increase the cost of the battery pack.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a battery temperature controlling apparatus includes a battery pack and a controller. The battery pack includes battery modules, and at least one of the battery modules includes an antenna and a coil. The antenna is configured to communicate with an adjacent one of the battery modules. The coil is configured to transmit and receive power with the adjacent one of the battery modules. The controller is configured to control a temperature of the battery pack based on information of the battery pack.

The controller may be further configured to control the temperature of the battery pack based on either one or both of the antenna and the coil.

The antenna may be further configured as a near field communication (NFC) antenna to perform NFC.

The antenna may be disposed on plural sides of the at least one battery module.

The coil may be disposed on plural sides of the at least one battery module.

The controller may be further configured to receive information of the battery pack from the antenna.

Information of the battery pack may include a temperature of the at least one battery module.

The controller may be further configured to control the temperature of the battery pack using the antenna in response to the temperature of the at least one battery module being less than or equal to a first reference value.

The controller may be further configured to control the temperature of the battery pack using a buffer connected to the antenna.

The controller may be further configured to control the temperature of the battery pack using the coil and the antenna in response to the temperature of the battery pack being less than or equal to a second reference value, and the second reference value may be less than the first reference value.

Information of the battery pack may include a state of charge (SOC) of the at least one battery module.

The controller may be further configured to calculate a chargeable power and a dischargeable power of the at least one battery module based on the SOC, and to control the temperature of the battery pack based on the chargeable power and the dischargeable power.

The controller may be further configured to group the at least one battery module to transmit and receive the power based on the chargeable power and the dischargeable power.

In another general aspect, a battery temperature controlling apparatus includes a battery pack and a controller. The battery pack includes at least one battery module. The controller is configured to control a temperature of the battery pack using an antenna included in the at least one battery module based on information of the battery pack.

The antenna may be configured as a near field communication (NFC) antenna to perform NFC.

The antenna may be disposed on plural sides of the at least one battery module.

The controller may be further configured to receive information of the battery pack from the antenna.

Information of the battery pack may include a temperature of the at least one battery module.

The controller may be further configured to control the temperature of the battery pack using the antenna in response to the temperature of the at least one battery module being less than or equal to a first reference value.

The controller may be further configured to control the temperature of the battery pack using a buffer connected to the antenna.

Other features and aspects will be apparent from the following detailed description, the drawings, and the claims.

### BRIEF DESCRIPTION OF THE DRAWINGS

FIG. 1 illustrates an example of a battery system.

FIG. 2 is a diagram illustrating an example of a battery system.

FIG. 3 is a perspective view illustrating an example of a battery system.

FIG. 4A is a perspective view illustrating an example of a first battery module.

FIG. 4B is a perspective view illustrating another example of a first battery.

FIG. 5 illustrates an example of an equivalent circuit of an antenna.

FIG. 6 illustrates an example of a slave battery management system (S-BMS).

FIG. 7 illustrates an example of a wireless communication circuit.

FIG. 8 illustrates an example of a master battery management system (M-BMS).

FIG. 9 illustrates another example describing an operation of the battery system.

FIG. 10 illustrates another example describing an operation of the battery system.

FIG. 11 is a perspective view illustrating an example of a battery system.

FIG. 12A is a perspective view illustrating an example of a first battery module.

FIG. 12B is a perspective view illustrating an example of a first battery module.

FIG. 13 illustrates an example of an S-BMS.

FIG. 14 illustrates an example of an integrated circuit.

FIG. 15 illustrates another example describing an operation of the battery system.

FIG. 16 illustrates another example describing an operation of the battery system.

FIG. 17 illustrates an example of describing a battery management system.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Although terms of “first” or “second” are used to explain various components, the components are not limited to the terms. These terms should be used only to distinguish one component from another component. For example, a “first” component may be referred to as a “second” component, or likewise, and the “second” component may be referred to as the “first” component within the scope of the right according to the concept of the present disclosure.

It will be understood that when a component is referred to as being “connected to” another component, the component can be directly connected or coupled to the other component or intervening components may be present.

As used herein, the singular forms are intended to include the plural forms as well, unless the context clearly indicates otherwise. It should be further understood that the terms “comprises/includes” and/or “comprising/including,” when used in this specification, specify the presence of stated features, integers, steps, operations, elements, components or a combination thereof, but do not preclude the presence or addition of one or more other features, integers, steps, operations, elements, components, and/or groups thereof.

Unless otherwise defined herein, all terms used herein including technical or scientific terms have the same meanings as those generally understood by one of ordinary skill in the art after an understanding of the present disclosure. Terms defined in dictionaries generally used should be construed to have meanings matching with contextual meanings in the related art and the present disclosure, and are not to be construed as an ideal or excessively formal meaning unless otherwise defined herein.

Hereinafter, examples will be described in detail with reference to the accompanying drawings, and like reference numerals in the drawings refer to like elements throughout.

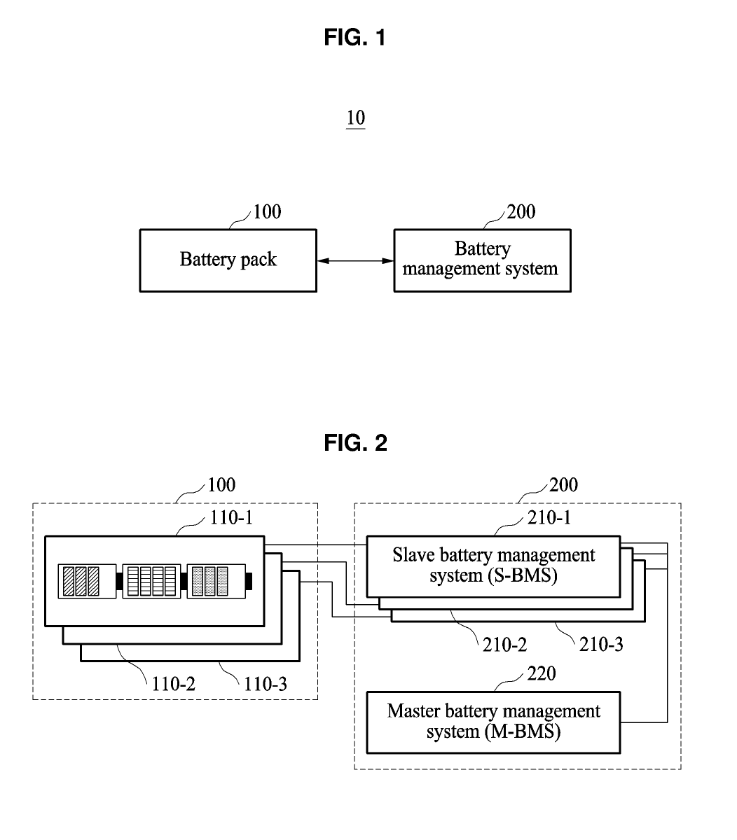

FIG. 1 illustrates an example of a battery system, and FIG. 2 is a diagram illustrating an example of a battery system. Below, though examples will be discussed with the battery system of FIG. 2 corresponding to the battery system of FIG. 1, such as through the use of like reference numbers, such descriptions for ease of description and thus examples are not limited thereto.

Thus, referring to FIGS. 1 and 2, a battery system 10 includes a battery pack 100 and a battery management system (BMS) 200.

The battery system 10 may be representative of or used in any device that includes a battery. For example, the battery system 10 may be used in an energy storage system (ESS), an electronic device, and a transportation apparatus. The transportation apparatus examples may be, for example, a vehicle, a smart mobility, an electric vehicle, a hybrid vehicle, and a plug-in hybrid vehicle. The battery system 10 may operate as a power source to components that constitute the electronic device and the transportation apparatus.

The battery pack 100 includes a plurality of battery modules 110-1, 110-2, and 110-3. The plurality of battery modules 110-1, 110-2, and 110-3 may be connected in series to each other. Here, each of the plurality of battery modules 110-1, 110-2, and 110-3 may include a plurality of battery cells. Herein, respective battery cells may be serially connected secondary cells, as a non-limiting example.

The battery management system 200 includes a master battery management system (M-BMS) 220 and a plurality of slave battery management systems (S-BMSs) 210-1, 210-2, and 210-3. The battery management system 200 may be a hardware controller, for example. Hereinafter, the master battery management system 220 is referred to as the M-BMS 220 and the slave battery management systems 210-1, 210-2, and 210-3 are referred to as the S-BMSs 210-1, 210-2, and 210-3, respectively.

The battery pack 100 and the battery management system 200 may be connected to each other. For example, the first S-BMS 210-1 may be connected to the first battery module 110-1, the second S-BMS 210-2 may be connected to the second battery module 110-2, and the third S-BMS 210-3 may be connected to the third battery module 110-3.

The battery management system 200 acquires information of the battery pack 100. Information of the battery pack 100 may include any one or any combination of any two or more of a voltage, a current, a temperature, an impedance, a state of charge (SOC), and a state of health (SOH) of a battery cell that constitutes each of the plurality of battery modules 110-1, 110-2, and 110-3.

Here, the battery management system 200 acquires the SOC or the SOH based on any one or any combination of any two or more of the voltage, the current, and the temperature of the battery cell.

For example, the first S-BMS 210-1 may acquire information of the first battery module 110-1. Likewise, the second S-BMS 210-2 may acquire information of the second battery module 110-2 and the third S-BMS 210-3 may acquire information of the third battery module 110-3.

The plurality of S-BMSs 210-1, 210-2, and 210-3 may transmit the acquired information to the M-BMS 220. Each of the plurality of S-BMSs 210-1, 210-2, and 210-3 and the M-BMS 220 may include an antenna. That is, the plurality of S-BMSs 210-1, 210-2, and 210-3 and the M-BMS 220 may wirelessly communicate using the antennas.

The antenna may be provided on each of the surfaces of each of the plurality of battery modules 110-1, 110-2, and 110-3. For example, each of the plurality of battery modules 110-1, 110-2, and 110-3 may include an antenna on a first surface and may also include an antenna on a second surface. The antenna of each of the plurality of battery modules 110-1, 110-2, and 110-3 may communicate with the antenna of the corresponding adjacent battery module 110-1, 110-2, or 110-3. The antenna may be configured as a near field communication (NFC) antenna that is configured to perform NFC.

Accordingly, the battery system 10 may be effectively configured to reduce noise. In addition, since the battery system 10 may be a relatively light and simplified structure, the energy density of the battery may be enhanced while minimizing production cost, maintenance frequency, and repairmen costs. Since the battery system 10 uses a wireless communication instead of a wired communication, battery cells may also be easily separated and replaced, thereby, enhancing the expandability and application flexibility of the battery cell.

Also, the battery management system 200 performs battery balancing based on information of the battery pack 100. That is, the battery management system 200 performs charging or discharging on the battery pack 100 based on information from the battery pack 100. The battery management system 200 may perform wireless charging or wireless discharging. Here, the battery management system 200 may include a coil configured to perform wireless charging or wireless discharging on an adjacent battery module(s) among the plurality of battery modules 110-1, 110-2, and 110-3.

The coil may be provided on surfaces of the battery pack 100. For example, each of the plurality of battery modules 110-1, 110-2, and 110-3 may include a coil on the first surface and another coil on a second surface. The coil of each of the plurality of battery modules 110-1, 110-2, and 110-3 may charge or discharge the corresponding adjacent battery module 110-1, 110-2, or 110-3.

The M-BMS 220 performs charging or discharging on the plurality of S-BMSs 210-1, 210-2, and 210-3 based on the SOCs or the SOHs of the plurality of battery modules 110-1, 110-2, and 110-3, respectively. That is, the plurality of S-BMSs 210-1, 210-2, and 210-3 charge or discharge the plurality of battery modules 110-1, 110-2, and 110-3, respectively, in response to a command of the M-BMS 220.

For example, the M-BMS 220 may perform charging or discharging based on an SOC of each of the plurality of battery modules 110-1, 110-2, and 110-3. The M-BMS 220 may determine SOC of each of the plurality of battery modules 110-1, 110-2, and 110-3, and may determine that at least one battery module, for example, the battery module 110-1 has a minimum SOC level.

The M-BMS 220 commands a battery module, for example, the battery modules 110-2 and 110-3 excluding battery modules having the minimum SOC level among the plurality of battery modules 110-1, 110-2, and 110-3. That is, the M-BMS 220 commands the S-BMSs 210-2 and 210-3 corresponding to the battery modules 110-2 and 110-3 excluding the battery module 110-1 which has the minimum SOC level from among the plurality of battery modules 110-1, 110-2, and 110-3. In response to the command, each of the battery modules 110-2 and 110-3 (not corresponding to the minimum SOC level) discharges energy to an adjacent battery module(s) among the battery modules 110-1, 110-2, and 110-3 to balance the batteries modules 110-1, 110-2, and 110-3. For example, the second battery module 110-2 may discharge energy to the first battery module 110-1 and the third battery module 110-3, and the third battery module 110-3 may discharge energy to the second battery module 110-2.

Also, the M-BMS 220 performs wireless charging and wireless discharging on at least one battery module, for example, the battery module 110-1, which corresponds to the battery with the minimum SOC level among the plurality of battery modules 110-1, 110-2, and 110-3. That is, in this example, the M-BMS 220 may command the wireless charging and the wireless discharging to the S-BMS 210-1 of the battery module 110-1 which corresponds to the battery with the minimum SOC level.

The battery module 110-1 in the example above that corresponds to the battery with the minimum SOC level may charge and discharge energy from the adjacent battery module, for example, the battery module 110-2. For example, the first battery module 110-1 may receive, for example, charge energy from the adjacent second battery module 110-2. Here, the second battery module 110-2 may discharge the energy received, for example, charged from the adjacent third battery module 110-3 and energy of the second battery module 110-2 to the first battery module 110-1. The energy of the second battery module 110-2 discharged from the second battery module 110-2 to the first battery module 110-1 may be energy corresponding to a difference between a current charge amount of the second battery module 110-2 and a charge amount of the first battery module 110-1.

In response to the command of the S-BMS 210-1, the first battery module 110-1 discharges the energy received, for example, charged from the second battery module 110-2. For example, the first battery module 110-1 may discharge energy to a low voltage direct current (DC)-to-DC converter (LDC). The LDC may charge an auxiliary battery or may supply power of 12 to 14 V_{DC} to a low voltage load of 0.5 kW to 3 kW.

If all of the battery modules 110-1, 110-2, and 110-3 have matching SOCs, the M-BMS 220 may terminate the battery balancing process.

The battery management system 200 may control the temperature of the battery pack 100 based on information of the battery pack 100. For example, the battery management system 200 may control the temperature of the battery pack 100 using an antenna or a coil. Accordingly, the battery system 10 may operate in a low temperature environment without malfunctioning, thus, increasing the lifespan of battery system 10.

If the temperature of any of the battery modules 110-1, 110-2, and 110-3 included in the battery pack 100 is less than or equal to a first reference value, the battery management system 200 may increase the temperature of the battery module using the antenna. The antenna may be provided on each side of each of the battery modules 110-1, 110-2, and 110-3. For example, the battery management system 200 may determine which of the battery modules 110-1, 110-2, and 110 has a temperature less than or equal to 0° C., and may increase the temperature of the determined battery module using the antenna. The battery management system 200 may increase the temperature by supplying a voltage or a current to the antenna.

If the temperature of any of the battery modules 110-1, 110-2, and 110-3 included in the battery pack 100 is less than or equal to a second reference value, the battery management system 200 may increase the temperature of the corresponding battery module using the antenna and the coil. Here, the second reference value may be less than the first reference value. The coil may be provided on each side of each of the battery modules 110-1, 110-2, and 110-3. For example, the battery management system 200 may determine which of the battery modules 110-1, 110-2, and 110-3 has a temperature less than or equal to −10° C., and may increase the temperature using the antenna and the coil. The battery management system 200 may increase the temperature by supplying a voltage or a current to the antenna and the coil.

For clarity of description, it is described that the plurality of battery modules 110-1, 110-2, and 110-3 are provided outside the battery management system 200. However, it is provided as an example only and any one or combination of all the plurality of battery modules 110-1, 110-2, and 110-3 may be provided in the battery management system 200.

Also, although it is illustrated that the battery pack 100 includes three battery modules 110-1, 110-2, and 110-3, it is provided as an example only. The battery pack 100 may include more or less numbers of battery modules than the described example.

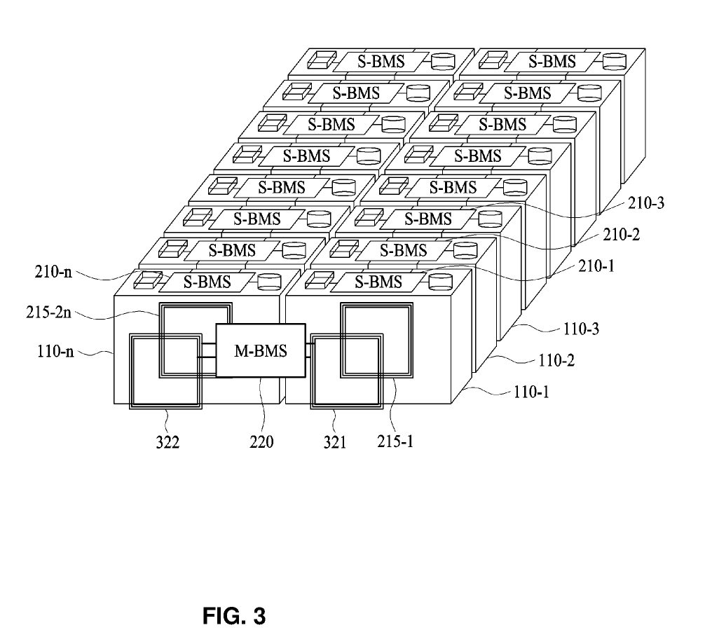

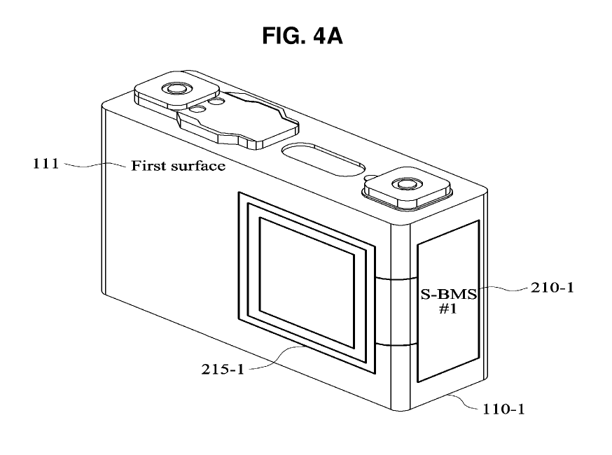

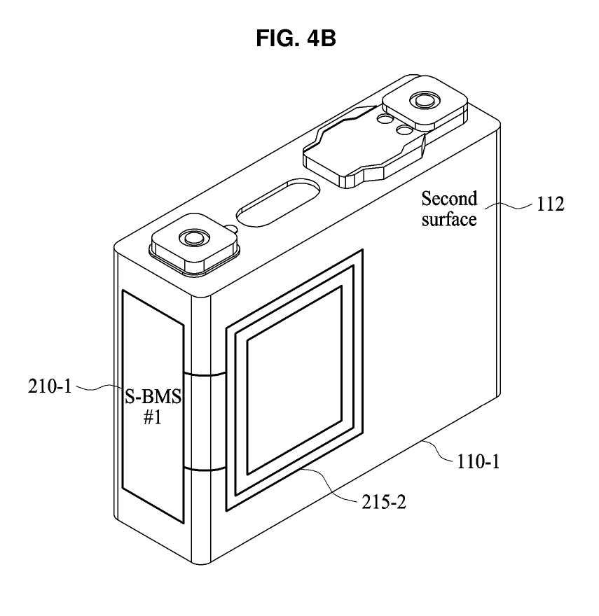

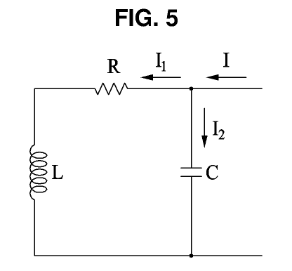

FIG. 3 is a perspective view illustrating an example of a battery system, FIG. 4A is a perspective view illustrating an example of a first battery module, FIG. 4B is a perspective view illustrating an example of a first battery module, and FIG. 5 illustrates an example of an equivalent circuit of an antenna. Below, though examples may be discussed with the battery system of FIG. 3 corresponding to the battery system of FIG. 1 and/or the example first battery modules of FIGS. 4A and 4B and antenna of FIG. 5 as corresponding to the first battery module and antenna of FIG. 3, such as through the use of like reference numbers, such descriptions are made for ease of description and thus examples are not limited thereto and such descriptions are also applicable to other battery system examples described herein.

Referring to FIG. 3, the battery system 10 includes the M-BMS 220, first antennas 321 and 322, battery modules 110-1 to 110-n, S-BMSs 210-1 to 210-n, and second antennas 215-1 to 215-2n. The first antennas 321 and 322 and the second antennas 215-1 to 215-2n may be configured as an NFC antenna that performs NFC.

Describing the first battery module 110-1 with reference to FIGS. 4A and 4B, the second antenna 215-1 is provided on a first surface 111 and the second antenna 215-2 is provided on a second surface 112. Although FIGS. 4A and 4B illustrate that the first S-BMS 210-1 is provided at the side of the first battery module 110-1, it is provided as an example only. The first S-BMS 210-1 may be provided on a top surface or a bottom surface of the first battery module 110-1.

Referring to FIG. 3, the M-BMS 220 may communicate with the S-BMSs 210-1 and 210-n of the adjacent battery modules 110-1 and 110-n through the first antennas 321 and 322. For example, the M-BMS 220 may communicate with the first S-BMS 210-1 through the first antenna 321 and may communicate with the n-th S-BMS 210-n through the first antenna 322. Accordingly, the M-BMS 220 may acquire information of the plurality of battery modules 110-1 to 110-n.

The M-BMS 220 transmits a wake-up signal to the first S-BMS 210-1 through the first antenna 321. In response to the wake-up signal, the first S-BMS 210-1 switches from an idle mode to an active mode. Herein, the idle mode refers to a sleep mode and the active mode refers to a mode for acquiring information of a battery module.

The M-BMS 220 may request the first S-BMS 210-1 of the first battery module 110-1 to verify the number of battery modules 110-1 to 110-n. For example, the M-BMS 220 may use a controller area network (CAN) message. Once the CAN message passes from the first S-BMS 210-1 to the n-th S-BMS 210-n, the n-th S-BMS 210-n may notify the M-BMS 220 that the number of battery modules 110-1 to 110-n is n.

The M-BMS 220 may request the plurality of battery modules 110-1 to 110-n for information. For example, the M-BMS 220 may request the first S-BMS 210-1 of the first battery module 110-1 for information of the first battery module 110-1.

The first S-BMS 210-1 acquires information from the connected first battery module 110-1. The information includes any one or any combination of any two or more of a voltage, a current, and a temperature. The first S-BMS 210-1 acquires any one or any combination of any two or more of the voltage, the current, and the temperature of the first battery module 110-1.

The first S-BMS 210-1 transmits the acquired information and the request of the M-BMS 220 to the second S-BMS 210-2 through the second antenna 215-2. Here, the second S-BMS 210-2 receives the information and the request from the first S-BMS 210-1 through the second antenna 215-3.

The second S-BMS 210-2 acquires information regarding any one or any combination of any two or more of the voltage, the current, and the temperature of the connected second battery module 110-2 and transmits the acquired information to the third S-BMS 210-3.

Likewise, the (n-1)-th S-BMS 210-n-1 transmits the acquired information and the request of the M-BMS 220 to the n-th S-BMS 210-n through the second antenna 215-2n-2. Here, the n-th S-BMS 210-n receives the information from the (n-1)-th S-BMS 210-n-1 through the second antenna 215-2n-1.

The n-th S-BMS 210-n transmits the acquired information of the plurality of battery modules 110-1 to 110-n to the M-BMS 220. For example, the n-th S-BMS 210-n may transmit information of the plurality of battery modules 110-1 to 110-n through the second antenna 215-2n. The M-BMS 220 may receive the information of the plurality of battery modules 110-1 to 110-n through the first antenna 322.

An antenna corresponding to the second antennas 215-1 to 215-2n will be described with reference to FIG. 5. An equivalent circuit of the antenna may be a circuit in which a resistor R and an inductor L are connected in series and a capacitor C is connected to the resistor R and the inductor L in parallel. The resistor R may indicate an internal resistance of the antenna.

Here, in the equivalent circuit, current of I[A] may flow. In detail, current of I₁[A] may flow through the resistor R and the inductor L, and current of I₂[A] may flow through the capacitor C. That is, according to Kirchhoff's law, I=I₁+I₂. If the current of I flows in the antenna, heat corresponding to I₁²[W] may be generated. That is, the antenna may operate as a heating element.

In response to detecting a battery module, for example, the second battery module 110-2, of which a temperature is less than or equal to the first reference value, the M-BMS 220 may control the temperature using the antenna attached to the second battery module 110-2. For example, the M-BMS 220 may control the first battery module 110-1 and the third battery module 110-3 adjacent to the second battery module 110-2 to communicate with the second battery module 110-2. Accordingly, the temperature of the second battery module 110-2 may increase, which may increase the temperature of the battery pack 100, thereby minimizing a heat loss.

The antenna, for example, the second antennas 215-1 to 215-2n, may be formed using alloy. For example, the antenna may include either one or both of titanium (Ti) and copper (Cu). Accordingly, the M-BMS 220 may efficiently control the temperature using the antenna, for example, the second antennas 215-1 to 215-2n.

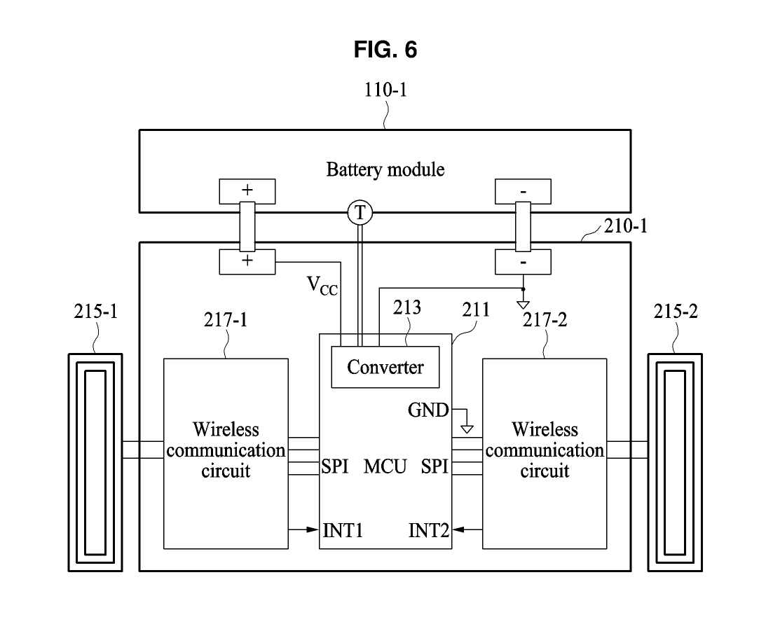

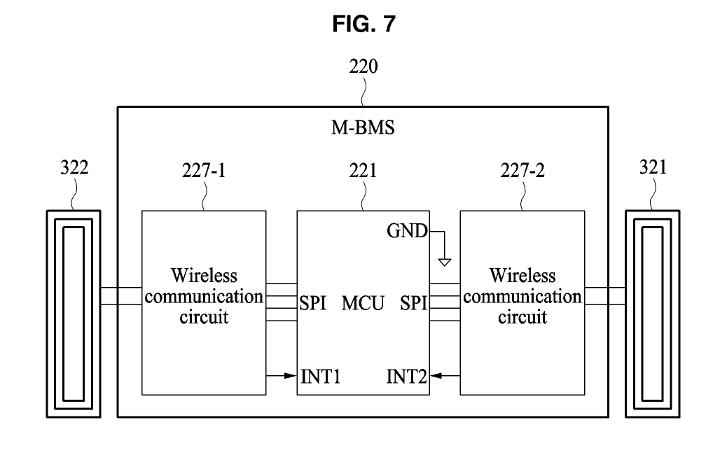

FIG. 6 illustrates an example of an S-BMS, and FIG. 7 illustrates an example of a wireless communication circuit. Below, though examples may be discussed with S-BMS of FIG. 6 corresponding to the S-BMS of FIG. 3 and the wireless communication circuit of FIG. 7 as corresponding to the wireless communication circuit of FIG. 6, such as through the use of like reference numbers, such descriptions are made for ease of description and thus examples are not limited thereto and such descriptions are also applicable to other battery system examples described herein.

Referring to FIGS. 6 and 7, the first S-BMS 210-1 may connect to the first battery module 110-1 to fit a polarity. For example, a + pole of the first S-BMS 210-1 and a + pole of the first battery module 110-1 are connected to each other, and a − pole of the first S-BMS 210-1 and a − pole of the first battery module 110-1 are connected to each other.

The first S-BMS 210-1 includes a controller 211, a converter 213, second antennas 215-1 and 215-2, and wireless communication circuits 217-1 and 217-2.

The controller 211 controls the overall operation of the first S-BMS 210-1. For example, the controller 211 may control the first S-BMS 210-1 to acquire information of the first battery module 110-1, to convert the acquired information, to transmit the converted information, or to receive information of an adjacent battery module. The controller 211 may be configured as a micro controller unit (MCU).

In response to the control, for example, a command of the controller 211, the converter 213 acquires and converts information of the first battery module 110-1. For example, the converter 213 may convert analog information to a digital signal. The converter 213 may be configured as an analog-to-digital (A/D) converter.

In response to the control, for example, the command of the controller 211, the wireless communication circuits 217-1 and 217-2 transmit the converted digital signal to the second antennas 215-1 and 215-2, respectively.

Each of the second antennas 215-1 and 215-2 transmits the converted digital signal to an adjacent antenna, for example, an adjacent first or second antenna. Here, the second antennas 215-1 and 215-2 may be understood as the equivalent circuit of FIG. 5.

The controller 211 may control the temperature of the first battery module 110-1 in response to a control, for example, a command, of the M-BMS 220. For example, in response to detecting that a temperature of the first battery module 110-1 is less than or equal to the first reference value, the M-BMS 220 may control or command the first S-BMS 210-1 to increase the temperature. Accordingly, the controller 211 may output current to the second antennas 215-1 and 215-2. Each of the second antennas 215-1 and 215-2 may be formed using alloy of Ti and Cu.

For example, once the controller 211 inputs current (Heat 1) to an amplifier 216 (see FIG. 7), the amplifier 216 may output the amplified current to the second antennas 215-1 and 215-2.

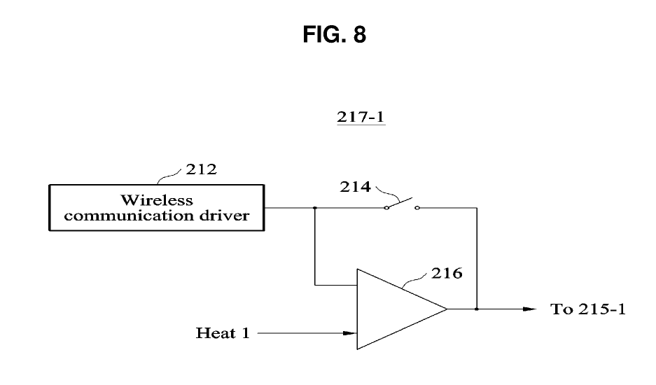

Referring to FIG. 8, a wireless communication circuit 217-1 includes a wireless communication driver 212, a switch 214, and the amplifier 216. Below, though examples may be discussed with the wireless communication circuit of FIG. 8 corresponding to the wireless communication circuit of FIG. 6, such as through the use of like reference numbers, such descriptions are made for ease of description and thus examples are not limited thereto and such descriptions are also applicable to other battery system examples described herein.

The wireless communication driver 212 may output a communication signal. The amplifier 216 may be configured as an operational amplifier. That is, the wireless communication circuit 217-1 may include a buffer structure. The switch 214 may control ON/OFF of the buffer operation.

The wireless communication circuit 217-1 may amplify the current in response to the control, for example, the command, of the controller 211. Accordingly, the temperature of the first battery module 110-1 may increase.

Although, FIG. 7 illustrates the wireless communication circuit 217-1 for clarity of description, it is provided as an example only. As a non-limiting example, a configuration and an operation of the wireless communication circuit 217-2 may be substantially identical to those of the wireless communication circuit 217-1.

FIG. 8 illustrates an example of an M-BMS. Similar to above, though examples may be discussed with the M-BMS of FIG. 8 corresponding to the M-BMS of FIG. 3, such as through the use of like reference numbers, such descriptions are made for ease of description and thus examples are not limited thereto and such descriptions are also applicable to other battery system examples described herein.

Referring to FIG. 8, the M-BMS 220 includes a controller 221, first antennas 321 and 322, and wireless communication circuits 227-1 and 227-2. As non-limiting examples, configurations and operations of the first antennas 321 and 322, and the wireless communication circuits 227-1 and 227-2 of FIG. 7 may be substantially identical to those of the second antennas 215-1 and 215-2 and the wireless communication circuits 217-1 and 217-2 of FIG. 6, again noting that e. Accordingly, a further description related thereto is omitted.

The controller 221 controls the overall operation of the M-BMS 220. The controller 221 may be configured as an MCU. For example, the controller 221 may control transmission and reception of a request, a command, and/or information with respect to the S-BMSs 210-1 to 210-n of the plurality of battery modules 110-1 to 110-n. The controller 221 may request and acquire information of the plurality of battery modules 110-1 to 110-n.

The controller 221 determines the temperature of each of the plurality of battery modules 110-1 to 110-n based on information acquired from the plurality of battery modules 110-1 to 110-n. The controller 221 detects any of the battery modules 110-1 to 110-n of which the temperature is less than or equal to the first reference value and controls the temperature of the detected battery module. For example, the controller 221 may control or command the S-BMSs 210-1 to 210-n of the corresponding battery modules 110-1 to -110-n to increase the temperature.

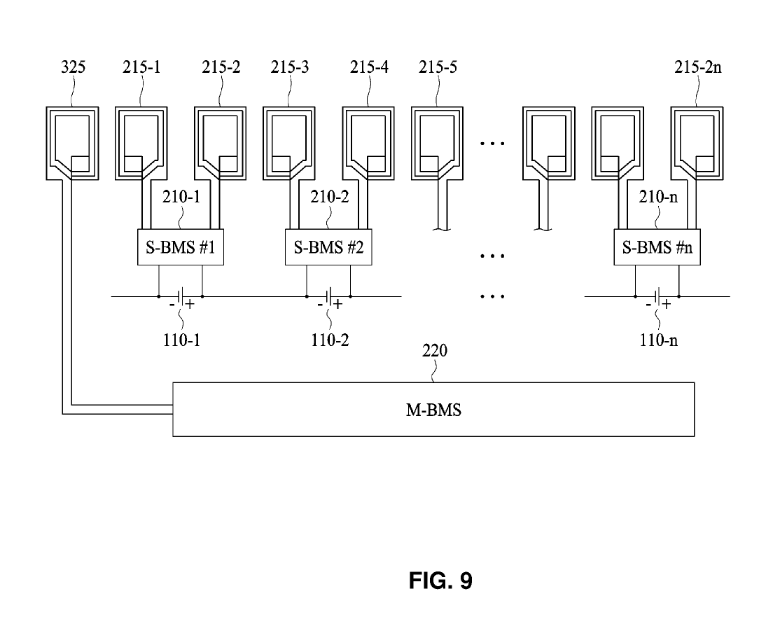

FIG. 9 illustrates an example of describing an operation a battery system. Below, though examples may be discussed with the battery system of FIG. 9 describing an operation of the battery system of FIG. 1, such as through the use of like reference numbers, such descriptions are made for ease of description and thus examples are not limited thereto and such descriptions are also applicable to other battery system examples described herein.

Referring to FIG. 9, the battery system 10 includes the M-BMS 220, a first antenna 325, battery modules 110-1 to 110-n, S-BMSs 210-1 to 210-n, and second antennas 215-1 to 215-2n.

The M-BMS 220 transmits a wake-up signal to the first S-BMS 210-1 through the first antenna 325 and requests information of the battery modules 110-1 to 110-n.

In response to the wake-up signal received through the second antenna 215-1, the first S-BMS 210-1 switches from an idle mode to an active mode and acquires information of the first battery module 110-1. Here, the first antenna 325 and the second antenna 215-1 that adjacently face each other are referred as an antenna pair. The first S-BMS 210-1 transmits the acquired information of the first battery modules 110-1 to the second S-BMS 210-2 through the second antenna 215-2.

The second S-BMS 210-2 acquires information of the first battery module 110-1 through the second antenna 215-3, switches from the idle mode to the active mode, and acquires information of the second battery module 110-2. Likewise, the second antenna 215-2 and the second antenna 215-3 that adjacently face each other are an antenna pair.

The n-th S-BMS 210-n acquires information of the battery modules 110-1 to 110-n-1 through the second antenna 215-2n1, switches from the idle mode to the active mode, and acquires information of the n-th battery module 110-n. The n-th S-BMS 210-n transmits the acquired information of the battery modules 110-1 to 110-n to the (n-1)-th S-BMS 210-n1. That is, the n-th S-BMS 210-n may transmit information of the battery modules 110-1 to 110-n in a reverse direction.

Once the first S-BMS 210-1 acquires information of the battery modules 110-1 to 110-n, the first S-BMS 210-1 transmits information of the battery modules 110-1 to 110-n to the M-BMS 220 through the second antenna 215-1.

The M-BMS 220 acquires information of the battery modules 110-1 to 110-n through the first antenna 325 and controls the temperature of each of the battery modules 110-1 to 110-n. The M-BMS 220 may control output current of the battery modules 110-1 to 110-n based on the temperatures of the battery modules 110-1 to 110-n.

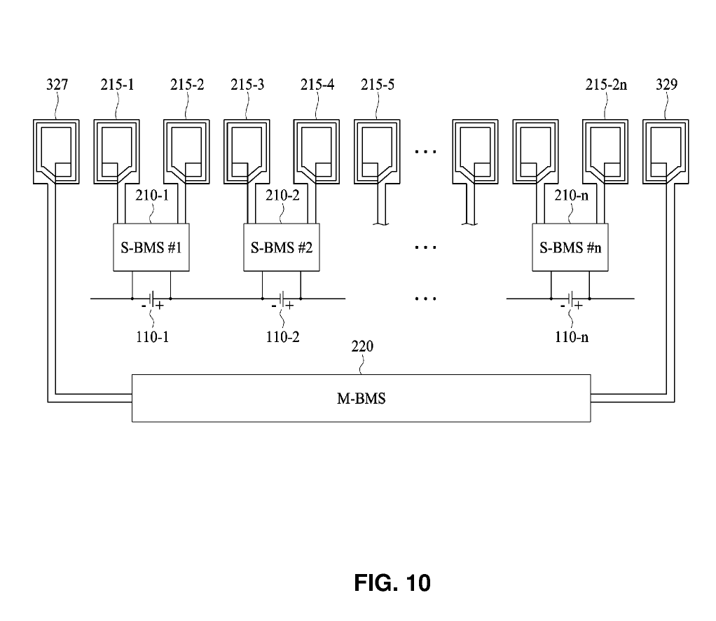

FIG. 10 illustrates an example of describing an operation of a battery system. Below, though examples may be discussed with the battery system of FIG. 10 describing an operation of the battery system of FIG. 1, such as through the use of like reference numbers, such descriptions are made for ease of description and thus examples are not limited thereto and such descriptions are also applicable to other battery system examples described herein.

Referring to FIG. 10, the battery system 10 includes the M-BMS 220, first antennas 327 and 329, battery modules 110-1 to 110-n, S-BMSs 210-1 to 210-n, and second antennas 215-1 to 215-2n.

The M-BMS 220 transmits a wake-up signal to the first S-BMS 210-1 through the first antenna 327 and requests information of the battery modules 110-1 to 110-n. The first S-BMS 210-1 acquires information of the first battery module 110-1 and transmits the acquired information to the adjacent second S-BMS 210-2.

The same principle described with reference to FIG. 9 may be applied herein. The n-th S-BMS 210-n acquires information of the battery modules 110-1 to 110-n1 through the second antenna 215-2n-1, switches from an idle mode to an active mode, and acquires information of the n-th battery module 110-n.

The n-th S-BMS 210-n transmits the acquired information of the battery modules 110-1 to 110-n to the M-BMS 220 through the second antenna 215-2n. That is, the M-BMS 220 acquires information of the battery modules 110-1 to 110-n through the first antenna 329 and controls a temperature of each of the battery modules 110-1 to 110-n. The M-BMS 220 may control output current of the battery modules 110-1 to 110-n based on the temperatures of the battery modules 110-1 to 110-n.

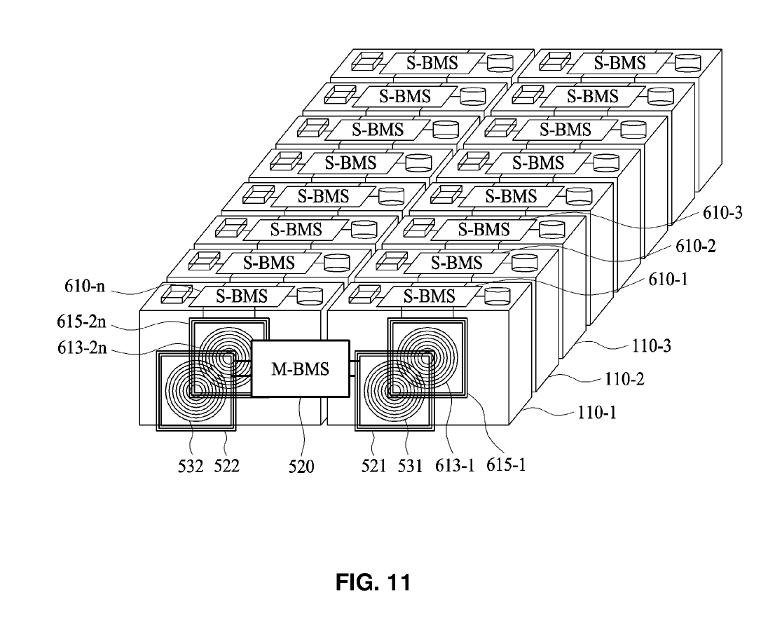

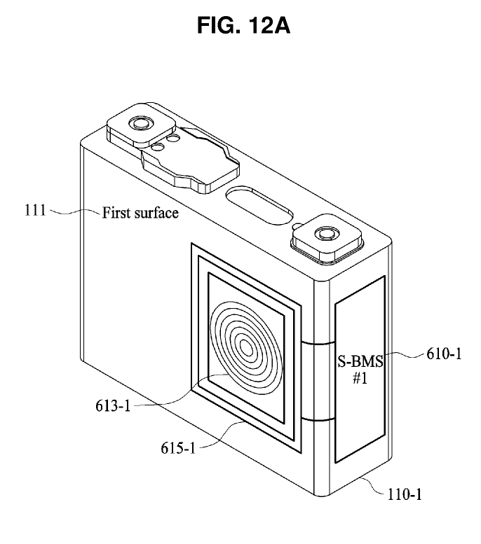

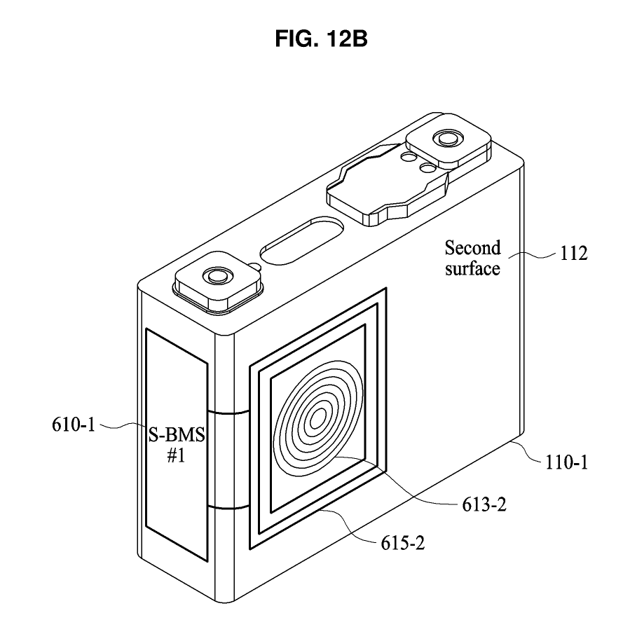

FIG. 11 is a perspective view illustrating an example of a battery system, FIG. 12A is a perspective view illustrating an example of a first battery module, and FIG. 12B is a perspective view illustrating an example of a first battery module. Below, though examples may be discussed with the example first battery modules of FIGS. 12A and 12B as corresponding to the first battery module of FIG. 11, such as through the use of like reference numbers, such descriptions are made for ease of description and thus examples are not limited thereto and such descriptions of FIGS. 11 through 12B are also applicable to other battery system examples described herein.

Referring to FIG. 11, the battery system 10 includes an M-BMS 520, first antennas 521 and 522, first coils 531 and 532, battery modules 110-1 to 110-n, S-BMSs 610-1 to 610-n, second antennas 615-1 to 615-2n, and second coils 613-1 to 613-2n. Here, the first antennas 521 and 522 and the second antennas 615-1 to 615-2n may be understood as the equivalent circuit of FIG. 5.

As non-limiting examples, configurations and operations of the M-BMS 520, the first antennas 521 and 522, the first coils 531 and 532, the battery modules 110-1 to 110-n, the S-BMSs 610-1 to 610-n, and the second antennas 615-1 to 615-2n of FIG. 11 may be substantially identical to those of the M-BMS 220, the first antennas 321 and 322, the battery modules 110-1 to 110-n, the S-BMSs 210-1 to 210-n, and the second antennas 215-1 to 215-2n of FIG. 3. Hereinafter, a different configuration is described.

The M-BMS 520 detects a battery module, for example, the second battery module 110-2, of which a temperature is less than or equal to the first reference value. The M-BMS 520 controls the temperature using the second antennas 615-3 and 615-4 provided to the second battery module 110-2. For example, the M-BMS 220 may control the first battery module 110-1 and the third battery module 110-3 adjacent to the second battery module 110-2 to communicate with the second battery module 110-2. Accordingly, the temperature of the second battery module 110-2 may increase, which may increase the temperature of the battery pack 100, thereby minimizing a heat loss.

Also, the M-BMS 520 detects a battery module, for example, the third battery module 110-3, of which a temperature is less than or equal the second reference value. The second reference value may be less than the first reference value. The M-BMS 520 controls the temperature using second antennas 615-5 and 615-6 provided to the third battery module 110-3 and coils 613-5 and 613-6. For example, the M-BMS 220 may control the second battery module 110-2 and a fourth battery module 110-4 adjacent to the third battery module 110-3 to perform communication and wireless power charging with the third battery module 110-2. Accordingly, the temperature of the third battery module 110-3 may increase, which may increase the temperature of the battery pack 100, thereby minimizing a heat loss.

When detecting the temperature of any of the battery modules 110-1 to 110-n, the M-BMS 520 may preferentially verify whether the temperature is less than or equal to the second reference value.

For example, if a temperature of a corresponding battery module among the battery modules 110-1 to 110-n is less than or equal to the second reference value, the M-BMS 520 may control or command a corresponding S-BMS among the S-BMS 610-1 to 610-n to control the temperature using corresponding second antennas among the second antennas 615-1 to 615-2n and second coils among the second coils 613-1 to 613-2n.

If the temperature of the corresponding battery module among the battery modules 110-1 to 110-n exceeds the second reference value, the M-BMS 520 may verify whether the temperature is less than or equal to the first reference value. If the temperature of the corresponding battery module among the battery modules 110-1 to 110-n is less than or equal to the first reference value, the M-BMS 520 may control or command a corresponding S-BMS among the S-BMS 610-1 to 610-n to control the temperature using corresponding second antennas among the second antennas 615-1 to 615-2n and second coils among the second coils 613-1 to 613-2n. If the temperature exceeds the first reference value, the M-BMS 520 may maintain a standby mode state.

Describing the first battery module 110-1 with reference to FIGS. 12A and 12B, the second antenna 615-1 is provided on the first surface 111 and the second antenna 615-2 is provided on the second surface 112. For clarity of description, although FIGS. 12A and 12B illustrate that the first S-BMS 610-1 is provided at the side of the first battery module 110-1, it is provided as an example only. The first S-BMS 610-1 may be provided on a top surface or a bottom surface of the first battery module 110-1.

Referring to FIG. 11, the battery system 10 performs battery balancing through the first coils 531 and 532 and the second coils 613-1 to 613-2n. The first coils 531 and 532 are provided at both sides of the M-BMS 520, respectively. The second coils 613-1 to 613-2n are provided at both sides of the respective corresponding battery modules 110-1 to 110-n.

The M-BMS 520 controls the temperature of the battery pack 100 based on information of the battery modules 110-1 to 110-n. For example, the M-BMS 520 may perform wireless charging or discharging based on information of the battery modules 110-1 to 110-n. In response to a command of the M-BMS 520, each of the S-BMSs 610-1 to 610-n may perform wireless charging or wireless discharging using the respective corresponding second coils 613-1 to 613-2n.

The M-BMS 520 performs charging or discharging based on SOC of each of the battery modules 110-1 to 110-n. The M-BMS 520 determines the SOC level of each of the battery modules 110-1 to 110-n and determines at least one battery module, for example, the battery module 110-1, having a minimum SOC level.

The M-BMS 520 may command a battery module, for example, the battery modules 110-2 to 110-n not having the minimum SOC level among the battery modules 110-1 to 110-n. That is, the M-BMS 520 may command wireless charging to the S-BMSs 210-2 to 210-n of the battery modules 110-2 to 110-n excluding the battery module 110-1 with the minimum SOC level among the battery modules 110-1 to 110-n. Accordingly, each of the battery modules 110-2 to 110-n not corresponding to the battery with the minimum SOC level may discharge energy to an adjacent battery module(s) using the second coils 613-1 to 613-2n. The energy discharged from each of the battery modules 110-2 to 110-n may be energy corresponding to a difference between a charge amount of each of the battery modules 110-2 to 110-n and a charge amount of the first battery module 110-1.

Also, the M-BMS 520 performs wireless charging and wireless discharging on at least one battery module, for example, the battery module 110-1 having the minimum SOC level among the battery modules 110-1 to 110-n. That is, the M-BMS 520 may command wireless charging and wireless discharging to the S-BMS 210-1 of the battery module 110-1 having the minimum SOC level among the battery modules 110-1 to 110-n. The at least one battery module, for example, the battery module 110-1 having the minimum SOC level may charge and discharge energy from the adjacent battery modules 110-2 to 110-n using the second coils 613-1 and 613-2.

In response to the command of the S-BMS 210-1, the first battery module 110-1 discharges the energy received, for example, charged from the adjacent battery modules 110-2 to 110-n. For example, the first battery module 110-1 may discharge the energy to the M-BMS 520 or an LDC using the second coils 613-1 and 613-2.

The M-BMS 520 or the LDC may perform wireless charging using the first coils 531 and 532. The M-BMS 520 or the LDC may charge an auxiliary battery or may supply power to a low voltage load. For example, the M-BMS 520 or the LDC may supply the power of 12 to 14V_{DC} to the low voltage load of 0.5 kW to 3 kW.

If all of the battery modules 110-1 to 110-n have a matching SOC level, the M-BMS 520 may terminate battery balancing.

The M-BMS 520 may control the temperature of the battery pack 100 based on the SOC level of each of the battery modules 110-1 to 110-n. The M-BMS 520 may calculate chargeable power and dischargeable power of each of the battery modules 110-1 to 110-n based on the SOC. The M-BMS 520 may control the temperature of the battery pack 100 based on the chargeable power and the dischargeable power.

For example, the M-BMS 520 may group at least one battery module among the battery modules 110-1 to 110-n based on the chargeable power and the dischargeable power. The M-BMS 520 may control the grouped battery module among the battery modules 110-1 to 110-n to perform mutual charging and discharging. The grouped battery module among the battery modules 110-1 to 110-n may perform mutual charging and discharging resulting in an increase in the temperature of the battery pack 100, thereby minimizing a heat loss.

The M-BMS 520 may consider the temperature of each of the battery modules 110-1 to 110-n as a factor when grouping the battery modules. For example, the M-BMS 520 may group a battery module of which a temperature is less than or equal to the first reference value and a battery module adjacent thereto among the battery modules 110-1 to 110-n. Also, the M-BMS 520 may group a battery module of which a temperature is less than or equal to the second reference value and a battery module adjacent thereto among the battery modules 110-1 to 110-n.

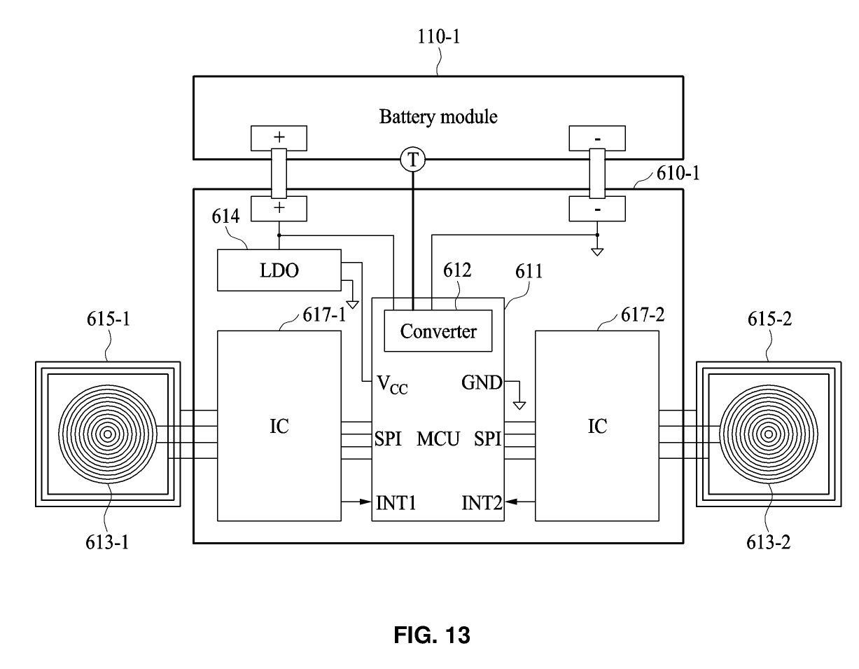

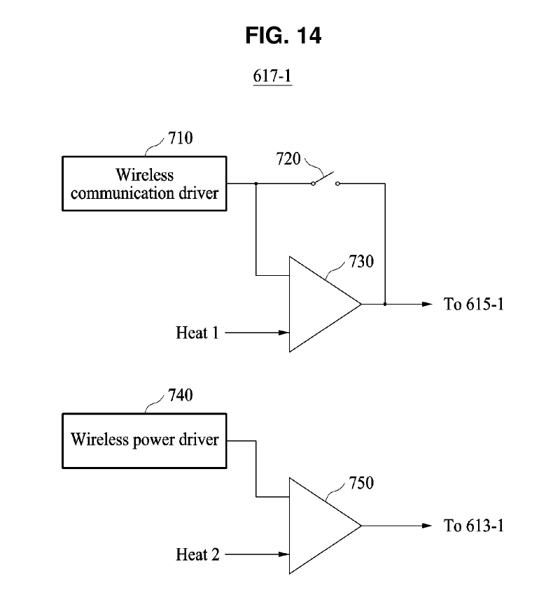

FIG. 13 illustrates an example of an S-BMS of FIG. 11, and FIG. 14 illustrates an example of an integrated circuit. Below, though examples may be discussed with S-BMS of FIG. 13 corresponding to the S-BMS of FIG. 11 and the integrated circuit of FIG. 14 as corresponding to the integrated circuit of FIG. 13, such as through the use of like reference numbers, such descriptions are made for ease of description and thus examples are not limited thereto and such descriptions are also applicable to other battery system examples described herein.

Referring to FIGS. 13 and 14, the first S-BMS 610-1 may connect to the first battery module 110-1 to fit a polarity. For example, a + pole of the first S-BMS 610-1 and a + pole of the first battery module 110-1 are connected to each other, and a − pole of the first S-BMS 610-1 and a − pole of the first battery module 110-1 are connected to each other.

The first S-BMS 610-1 includes a controller 611, a converter 612, second coils 613-1 and 613-2, a linear regulator 614, second antennas 615-1 and 615-2, and integrated circuits (ICs) 617-1 and 617-2.

As non-limiting examples, configurations and operations of the controller 611, the converter 612, and the second antennas 615-1 and 615-2 of FIG. 13 may be substantially identical to those of the controller 211, the converter 213, and the second antennas 215-1 and 215-2 of FIG. 6. Accordingly, a further description related thereto is omitted.

The first S-BMS 610-1 transmits information of the first battery module 110-1 to the M-BMS 520, and performs battery balancing and temperature control in response to a command of the M-BMS 520.

The linear regulator 614 controls a voltage that is input to the controller 611. For example, the linear regulator 614 may control a voltage of 2.5 to 3V to be input to the controller 611. The linear regulator 614 may be configured as a low drop out (LDO) regulator.

The controller 611 controls the overall operation of the first S-BMS 610-1. For example, the controller 611 may control the first S-BMS 610-1 to acquire information of the first battery module 110-1, to convert the acquired information, to transmit the converted information, or to receive information of an adjacent battery module. The controller 611 may be configured as an MCU.

In response to the control, for example, a command of the controller 611, the converter 612 converts the acquired information. For example, the converter 612 may convert the acquired information to a digital signal.

Referring to FIG. 14, the IC 617-1 includes a wireless communication driver 710, a switch 720, amplifiers 730 and 750, and a wireless power driver 740. As a non-limiting examples, a configuration and an operation of the wireless communication driver 710, the switch 720, and the amplifier 730 of FIG. 14 may be substantially identical to those of the wireless communication driver 212, the switch 214, and the amplifier 216 of FIG. 7.

The wireless power driver 740 may output a signal to wirelessly transmit and receive power. The amplifier 750 may be configured as an operational amplifier.

The controller 611 may control a temperature of the first battery module 110-1 in response to a control, for example, a command of the M-BMS 520.

For example, in response to detecting that the temperature of the first battery module 110-1 is less than or equal to the first reference value, the M-BMS 520 may control or command the first S-BMS 610-1 to increase the temperature using the second antennas 615-1 and 615-2. Accordingly, the controller 611 may output current to the second antennas 615-1 and 615-2. Each of the second antennas 615-1 and 615-2 may be formed using alloy of Ti and Cu. Once the controller 611 inputs current (Heat 1) to the amplifier 730, the amplifier 730 may output the amplified current to the second antennas 615-1 and 615-2.

In response to detecting that the temperature of the first battery module 110-1 is less than or equal to the second reference value, the M-BMS 520 may control, for example, command the first S-BMS 610-1 to increase the temperature using the second antennas 615-1 and 615-2 and the second coils 613-1 and 613-2. Accordingly, the controller 611 may output current to the second antennas 615-1 and 615-2 and the second coils 613-1 and 613-2. Once the controller 611 inputs current (Heat 2) to the amplifier 750, the amplifier 750 may output the amplified current to the second coils 613-1 and 613-2.

Although FIG. 14 illustrates the IC 617-1 for clarity of description, it is provided as an example only. As a non-limiting example, a configuration and an operation of the IC 617-2 may be substantially identical to those of the IC 617-1.

In response to the control, for example, the command of the controller 611, the ICs 617-1 and 617-2 output the converted digital signal to the second antennas 615-1 and 615-2, respectively.

Each of the second antennas 615-1 and 615-2 transmits the converted digital signal to an adjacent antenna, for example, an adjacent first or second antenna.

Also, in response to the control, for example, the command of the controller 611, the ICs 617-1 and 617-2 output a charging signal or a discharging signal to the second coils 613-1 and 613-2, respectively.

In response to the command of the first S-BMS 610-1, each of the second coils 613-1 and 613-2 may perform wireless charging or wireless discharging on an adjacent battery module.

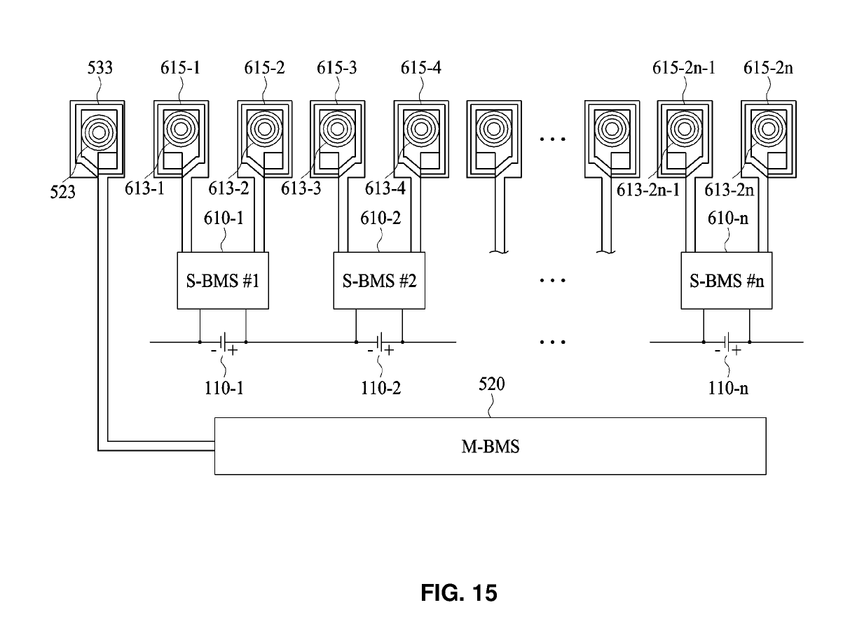

FIG. 15 illustrates an example of describing an operation of a battery system. Below, though examples may be discussed with the battery system of FIG. 15 describing an operation of the battery system of FIG. 1, such as through the use of like reference numbers, such descriptions are made for ease of description and thus examples are not limited thereto and such descriptions are also applicable to other battery system examples described herein.

Referring to FIG. 15, the battery system 10 includes the M-BMS 520, a first antenna 533, a first coil 523, battery modules 110-1 to 110-n, S-BMS 610-1 to 610-n, second coils 613-1 to 613-2n, and second antennas 615-1 to 615-2n.

As non-limiting examples, configurations and operations of the M-BMS 520, the first antenna 533, the battery modules 110-1 to 110-n, the S-BMSs 610-1 to 610-n, and the second antennas 615-1 to 615-2n of FIG. 15 may be substantially identical to those of the M-BMS 220, the first antenna 325, the battery modules 110-1 to 110-n, the S-BMSs 210-1 to 210-n, and the second antennas 215-1 to 215-2n of FIG. 9. Accordingly, a further description related thereto is omitted.

The M-BMS 520 performs battery balancing and temperature control using the first coil 523. For example, in response to detecting a battery module of which a temperature is less than or equal to the second reference value among the battery modules 110-1 to 110-n, the M-BMS 520 may charge or discharge energy through the first coil 523.

Here, the M-BMS 520 groups at least one battery module among the battery modules 110-1 to 110-n based on SOC. For example, the M-BMS 5820 may calculate chargeable power and dischargeable power of each of the battery modules 110-1 to 110-n based on the SOC and may perform grouping. The M-BMS 520 may control the grouped battery module among the battery modules 110-1 to 110-n to perform mutual charging and discharging. The grouped battery module among the battery modules 110-1 to 110-n may perform mutual charging and discharging and the temperature of the battery pack 100 may increase, thereby minimizing a heat loss.

For example, the M-BMS 520 may determine at least one battery module having a minimum SOC level among the battery modules 110-1 to 110-n.

The M-BMS 520 may command discharging to an S-BMS, for example, at least one of the S-BMSs 610-1 to 610-n, of a battery module, for example, at least one of the battery modules 110-1 to 110-n not having the minimum SOC. That is, the M-BMS 520 may discharge energy until the S-BMS, for example, at least one of the S-BMSs 610-1 to 610-n, of the battery module, for example, at least one of the battery modules 110-1 to 110-n not having the minimum SOC level reaches the minimum SOC level.

The M-BMS 520 may command charging and discharging to an S-BMS, for example, at least one of the S-BMSs 610-1 to 610-n, of a battery module, for example, at least one of the battery modules 110-1 to 110-n having the minimum SOC level. That is, the S-BMS, for example, at least one of the S-BMSs 610-1 to 610-n, of the battery module, for example, at least one of the battery modules 110-1 to 110-n having the minimum SOC level may pass the energy transferred from an adjacent battery module among the battery modules 110-1 to 110-n.

The M-BMS 520 or the LDC performs wireless charging using the first coil 523. The M-BMS 520 or the LDC charges an auxiliary battery or supplies the power to a low voltage load. For example, the M-BMS 520 or the LDC may supply power of 12 to 14V_{DC} to the low voltage load of 0.5 kW to 3 kW.

If temperatures of all of the battery modules 110-1 to 110-n exceed the first reference value, the M-BMS 520 may maintain a standby mode state.

If all of the battery modules 110-1 to 110-n n have the matching SOC, the M-BMS 520 may terminate battery balancing.

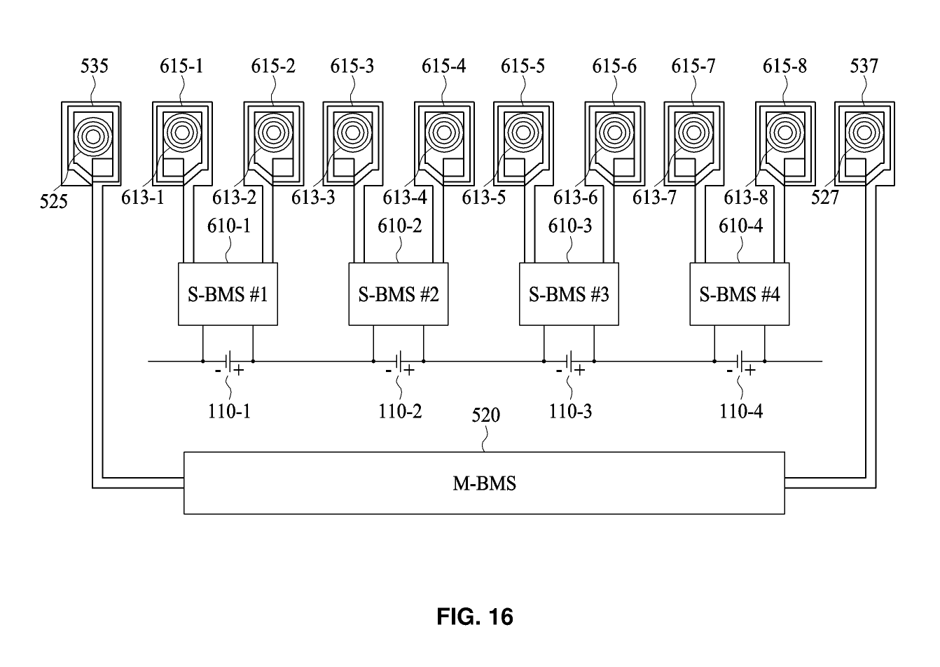

FIG. 16 illustrates an example of describing an operation of a battery system. Below, though examples may be discussed with the battery system of FIG. 16 describing an operation of the battery system of FIG. 1, such as through the use of like reference numbers, such descriptions are made for ease of description and thus examples are not limited thereto and such descriptions are also applicable to other battery system examples described herein.

Referring to FIG. 16, the battery system 10 includes the M-BMS 520, first antennas 535 and 537, first coils 525 and 527, battery modules 110-1 to 110-4, S-BMSs 610-1 to 610-4, second coils 613-1 to 613-8, and second antennas 615-1 to 615-8.

In this example, it is assumed that a charge rate of the first battery module 110-1 is 80%, a charge rate of the second battery module 110-2 is 80%, a charge rate of the third battery module 110-3 is 70%, and a charge rate of the fourth battery module 110-4 is 70%. For clarity of description, the charging rates of the battery modules 110-1 to 110-4 are arbitrarily set and are not limited thereto.

The M-BMS 520 performs battery balancing and temperature control using the first coils 525 and 527. For example, the M-BMS 520 may charge or discharge energy through the first coils 525 and 527.

In this example, the M-BMS 520 determines the battery modules 110-3 and 110-4 having a minimum SOC level based on information of the battery modules 110-1 to 110-4. The SOC may include a charge rate.

The M-BMS 520 commands discharging to the S-BMSs 610-1 and 610-2 of the battery modules 110-1 and 110-2 not having the minimum SOC level. That is, the M-BMS 520 commands the S-BMSs 610-1 and 610-2 of the battery modules 110-1 and 110-2 not having the minimum SOC level until the SOC level of each of the battery modules 110-1 and 110-2 reaches a minimum. The battery modules 110-1 and 110-2 may discharge energy until the charging rate reaches 70%.

For example, the first battery module 110-1 may discharge energy through the second coils 613-1 and 613-2. The M-BMS 520 or an LDC may receive the energy discharged through the second coil 613-1 through the first coil 525. The second battery module 110-2 may receive the energy discharged through the second coil 613-2 through the second coil 613-3.

Also, the second battery module 110-2 may discharge the energy through the second coils 613-3 and 613-4. That is, the second battery module 110-2 may discharge the energy to the first battery module 110-1 or the third battery module 110-3.

The M-BMS 520 commands charging and discharging to the S-BMSs 610-3 and 610-4 of the battery modules 110-3 and 110-4 having the minimum SOC levels. That is, the S-BMSs 610-3 and 610-4 of the battery module 110-3 and 110-4 having the minimum SOC may pass the energy transferred from the adjacent battery modules 110-1 and 110-2.

The third battery module 110-3 and the fourth battery module 110-4 may pass the energy received from the first battery module 110-1 and the second battery module 110-2. The fourth battery module 110-4 may discharge the energy through the second coils 613-7 and 613-8. The M-BMS 520 or the LDC may receive the energy discharged through the second coil 613-8 through the first coil 527.

The M-BMS 520 or the LDC may charge an auxiliary battery or may supply power to a low voltage load using the energy charged from the first coils 525 and 527. For example, the M-BMS 520 or the LDC may supply the power of 12 to 14V_{DC} to the low voltage load of 0.5 kW to 3 kW.

The M-BMS 520 may perform battery balancing and temperature control until the temperatures of all of the battery modules 110-1 to 110-4 exceed the first reference value.

For clarity of description, although FIG. 16 illustrates four battery modules 110-1 to 110-4, it is provided as an example only. Accordingly, a number of S-BMSs, a number of second coils, and a number of second antennas may vary based on a number of battery modules.

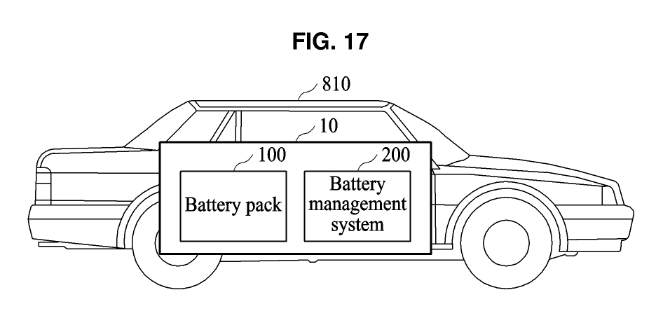

FIG. 17 illustrates an example of describing a battery management system. Below, the battery management system of FIG. 17 may correspond to any one, any combination, or all battery systems or battery management systems described herein with respect to FIGS. 1-16, and thus, may be explained through the use of like reference numbers as above. In this regard, such descriptions are made for ease of description and thus examples are not limited thereto and such descriptions are also applicable to other battery system examples.

Accordingly, FIG. 17 illustrates a vehicle 810 that may be an electric vehicle, a hybrid vehicle, or a plug-in hybrid vehicle.

The battery system 10 includes the battery pack 100 and the battery management system 200.

The battery pack 100 may include a plurality of battery modules. Each of the battery modules may include a plurality of battery cells.

The battery management system may include an M-BMS and a plurality of S-BMSs. Each of the plurality of S-BMSs may perform the same operation.

The S-BMS may collect physical quantity information of each of a plurality of battery cells included in a battery module. For example, physical quantity information may include, for example, any one or any combination of any two or more of voltage information, current information, temperature information, and impedance information. The S-BMS may transmit the collected physical quantity information to the M-BMS. For example, the S-BMS may transmit the collected physical quantity information to the M-BMS through controller area network (CAN) communication.

The M-BMS may determine state information of the battery pack 100, the battery cell, and/or the battery module based on the collected physical quantity information. The state information may include either one or both of an SOC or and SOH.

Also, the M-BMS records output information associated with discharge of the battery cell. The output information may include, for example, information about the output power of the battery pack 100, however, is not limited thereto. The output information associated with discharge of the battery cell may include information associated with the output power of the battery cell or the battery module. The M-BMS may sense the output power of the battery pack 100 during a desired period of time. The M-BMS may record the sensed output power.

The M-BMS determines output pattern information of the battery pack 100 based on the recorded output information. The M-BMS determines an adjustment cutoff physical quantity of the battery cell based on the determined output pattern information. The M-BMS changes the adjustment cutoff physical quantity of the battery cell. For example, the M-BMS may change a setting value about cutoff voltage of a protection circuit of the battery cell.

If the output pattern information corresponds to a low output pattern, the M-BMS may adjust a discharge cutoff physical quantity of the battery cell to be less than a discharge cutoff physical quantity preset for the battery cell. In this case, available capacity of the battery cell may be greater than pre-adjustment available quantity. Also, the M-BMS may output desired power to a relatively small number of battery cells. That is, since a number of battery cells in the battery pack 100 may be reduced when designing the battery pack 100, it is possible to reduce cost of the battery pack 100.

The M-BMS may receive request output information from a power management system, for example, an electronic control unit (ECU), within the vehicle 810. The request output information may include information, for example, a power command value, about power calculated by the power management system in response to a user pushing an accelerator of the vehicle 810. The M-BMS may determine outputable power information of the battery pack 100 based on state information, for example, an SOC and/or an SOH, of the battery pack 100.

If the output request information is less than or equal to the outputable power information, the M-BMS may control the battery pack 100 so that power corresponding to the request output information may be output. The output power of the battery pack 100 may be transferred to an inverter within the vehicle 810. The inverter may convert the output power and may transfer the converted power to an electric motor.

If the request output information is greater than the outputable power information, the M-BMS may control the battery pack 100 so that power corresponding to the outputable power information may be output. Also, the M-BMS may display, on a display, a message indicating that the power corresponding to the request output information is not output and/or that charging is required.

Depending on example embodiments, the battery management system may be provided to a large storage device, such as an ESS. Also, the battery management system may be provided to an electronic device or a device management system to which a rechargeable battery is mounted.

The battery management system 200, the master battery management system (M-BMS) 220, and the slave battery management systems (S-BMSs) 210-1, 210-2, and 210-3, in FIGS. 1-17 that perform the operations described in this application are implemented by hardware components configured to perform the operations described in this application that are performed by the hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods that perform the operations described in this application are performed by computing hardware, for example, by one or more processors or computers, implemented as described above executing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control a processor or computer to implement the hardware components and perform the methods as described above are written as computer programs, code segments, instructions or any combination thereof, for individually or collectively instructing or configuring the processor or computer to operate as a machine or special-purpose computer to perform the operations performed by the hardware components and the methods as described above. In one example, the instructions or software include machine code that is directly executed by the processor or computer, such as machine code produced by a compiler. In another example, the instructions or software include higher-level code that is executed by the processor or computer using an interpreter. Programmers of ordinary skill in the art after reading the present disclosure can readily write the instructions or software based on the block diagrams and the flow charts illustrated in the drawings and the corresponding descriptions in the specification, which disclose algorithms for performing the operations performed by the hardware components and the methods as described above.

The instructions or software to control a processor or computer to implement the hardware components and perform the methods as described above, and any associated data, data files, and data structures, are recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and providing the instructions or software and any associated data, data files, and data structures to a processor or computer so that the processor or computer can execute the instructions.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An apparatus with battery temperature control, comprising:
a battery pack comprising battery modules, with at least one of the battery modules comprising:
an antenna configured to communicate with a corresponding adjacent one of the battery modules; and
a coil configured to transmit and receive power with the corresponding adjacent one of the battery modules; and
a controller configured to control a temperature of the battery pack based on information of the battery pack.

2. The apparatus of claim 1, wherein the controller is further configured to control the temperature of the battery pack based on either one or both of the antenna and the coil.

3. The apparatus of claim 1, wherein the antenna is further configured as a near field communication (NFC) antenna to perform NFC.

4. The apparatus of claim 1, wherein the antenna is disposed on plural sides of the at least one battery module.

5. The apparatus of claim 1, wherein the coil is disposed on plural sides of the at least one battery module.

6. The apparatus of claim 1, wherein the controller is further configured to receive information of the battery pack from the antenna.

7. The apparatus of claim 1, wherein information of the battery pack comprises a temperature of the at least one battery module.

8. The apparatus of claim 7, wherein the controller is further configured to control the temperature of the battery pack using the antenna in response to the temperature of the at least one battery module being less than or equal to a first reference value.

9. The apparatus of claim 1, wherein the controller is further configured to control the temperature of the battery pack using a buffer connected to the antenna.

10. The apparatus of claim 8, wherein the controller is further configured to control the temperature of the battery pack using the coil and the antenna in response to the temperature of the battery pack being less than or equal to a second reference value, and
the second reference value is less than the first reference value.

11. The apparatus of claim 1, wherein information of the battery pack comprises a state of charge (SOC) of the at least one battery module.

12. The apparatus of claim 11, wherein the controller is further configured to calculate a chargeable power and a dischargeable power of the at least one battery module based on the SOC, and to control the temperature of the battery pack based on the chargeable power and the dischargeable power.

13. The apparatus of claim 12, wherein the controller is further configured to group the at least one battery module to transmit and receive the power based on the chargeable power and the dischargeable power.

14. An apparatus with battery temperature control, comprising:
a battery pack comprising at least one battery module; and
a controller configured to control a temperature of the battery pack using an antenna included in the at least one battery module based on information of the battery pack.

15. The apparatus of claim 14, wherein the antenna is configured as a near field communication (NFC) antenna to perform NFC.

16. The apparatus of claim 14, wherein the antenna is disposed on plural sides of the at least one battery module.

17. The apparatus of claim 14, wherein the controller is further configured to receive information of the battery pack from the antenna.

18. The apparatus of claim 14, wherein information of the battery pack comprises a temperature of the at least one battery module.

19. The apparatus of claim 18, wherein the controller is further configured to control the temperature of the battery pack using the antenna in response to the temperature of the at least one battery module being less than or equal to a first reference value.

20. The apparatus of claim 14, wherein the controller is further configured to control the temperature of the battery pack using a buffer connected to the antenna.
